(19) United States
(12) Patent Application Publication
(10) Pub. No.: US 2022/0325041 A1
(43) Pub. Date: Oct. 13, 2022

(54) TITLE: A WATER-SOLUBLE CO-POLYESTER POLYMER AND A PROCESS OF SYNTHESIS THEREOF

(71) Applicants: Akshay Narayan Maikap, Indore (IN); Tanushree Maikap, Indore (IN)

(72) Inventors: Akshay Narayan Maikap, Indore (IN); Tanushree Maikap, Indore (IN)

(21) Appl. No.: 17/641,050

(22) PCT Filed: Sep. 25, 2019
(86) PCT No.: PCT/IB2019/058113

§ 371 Date: Mar. 7, 2022

(30) Foreign Application Priority Data
Sep. 7, 2019 (IN) 201921036125

(51) Int. Cl. C08G 63/688; C09D 167/02

(52) U.S. Cl. CPC C08G 63/6886; C09D 167/02

(57) ABSTRACT

The present invention relates to a water-soluble co-polyester polymer. The polymer of the present invention is used for inline coating of BOPET film manufacturing, coating of BOPET film used as primer for vacuum metallization and surface coating of Aluminum sheets. The polymer of the present invention provides wide range of printability performances and high metal to film bond strength with minimum gain in weight. The disclosed polymer also provides Tape Test resistant printing and retort resistant layered/composite film.

### FIELD OF THE INVENTION

The present invention relates to co-polyester polymer. Particularly, the present invention relates to water-soluble co-polyester polymer. Specifically, the present invention relates to water-soluble co-polyester polymer used for substrate coating. The process of synthesis is also disclosed.

### BACKGROUND OF THE INVENTION

Biaxially oriented polyethylene terephthalate (BOPET) is a polyester film made from stretched polyethylene terephthalate (PET) and is used for its high tensile strength, chemical and dimensional stability, transparency, reflectivity, gas and aroma barrier properties, and electrical insulation. The manufacturing process begins with a resin of molten polyethylene terephthalate (PET) being extruded onto a chill roll, which quenches it into the amorphous state. It is then biaxially oriented by drawing under special thermal condition, which causes molecular relaxation. The most common way of doing this is the sequential process, in which the film is first drawn in the machine direction using heated rollers and subsequently drawn in the transverse direction, i.e. orthogonally to the direction of travel, in a heated oven. It is also possible to draw the film in both directions simultaneously, although the equipment required for this is somewhat more elaborate. The temperature, orientation, and crystallinity percentage governs the final properties of the BOPET films.

This biaxially oriented film design is largely employed to the packaging material for developing packaging products. The surface energy of the biaxially oriented polyethylene terephthalate (BOPET) films is very less 44-46 Dyne/cm and it's adhesion to ink (printing) or metallized Aluminum is very less, which makes it less suitable for printing or Aluminum metallization. Generally, the BOPET films are either corona treated or coated with other co-polyester polymers to increase their surface energy. The corona treated surface of the BOPET base film degrades during placement or use. If the temperature and humidity percentage are high, the degradation will be faster. Further, the coating polymers are mostly solvent-based and thus, the evaporation of these solvents may harm the environment. Many efforts have been done so far to obtain a water-based co-polyester polymer, which can obviate the drawbacks of prior-art and will provide an environmental friendly solution to the problem. Similarly, there is no polymer is disclosed which can provide wide range of printability performance when coated over BOPET or Aluminum sheets.

Therefore, there is an urgent need for inventing and developing a water soluble polymer which when coated to BOPET film provide increase in surface energy along with wide range of printability performances and high metal to film bond strength with minimum gain in weight. Further, there is an unmet need to invent and develop a water-soluble polymer, which can be used to coat Aluminum sheets to impart wide range of printability performance to it with minimum gain in weight. There exists also an unmet need of a polymer, which can provide retort resistant printing in packaging industry.

### SUMMARY OF THE INVENTION

A water-soluble co-polyester polymer used for substrate coating is provided.

In one aspect, the present invention provides a water-soluble co-polyester polymer, which can be used for inline or offline coating of substrate to increase their surface energy and surface adhesion.

In one another aspect, the present invention provides a water-soluble co-polyester polymer, which can be used for inline coating or offline coating of substrate provide wide range of printability performance.

In one another aspect, the present invention provides a water-soluble co-polyester polymer which when inline coated on BOPET films enhance their surface properties, provides wide range of printability performance and metal to film bond strength.

In one another aspect, the present invention provides a water-soluble co-polyester polymer which when coated on metal sheets or foil (e.g. Aluminum) enhance the compatibility and hence adhesion of ink, provide wide range of printability performance.

In one another aspect, the present invention provides a water-soluble co-polyester polymer, which imparts excellent adhesion, and printability properties to the substrate when coated with the water-soluble co-polyester polymer.

In one another aspect, the present invention provides a water-soluble co-polyester polymer which provides excellent adhesion to ink and Aluminum (metallization) when the BOPET is coated with the water soluble co-polyester polymer. Thus, it provides wide range of printability performance over the BOPET inline coated with the co-polyester polymer of the present invention. Similarly, the inline coating of BOPET with the co-polyester polymer of the present invention also increases adhesion to Aluminum metal in the process of metallization and thus provide excellent metal to film bond strength.

In one another aspect, the present invention provides a water-soluble co-polyester polymer, which provides a retort resistance packaging solution for retort packaging.

In one another aspect, the present invention provides a water-soluble co-polyester polymer, which can be coated in very thin layer thickness and at very less weight gain.

In one another aspect, the present invention provides a water-soluble co-polyester polymer for substrate coating, which provides a wide range of printability performance with water-based ink systems, thus avoiding solvent-based ink systems.

In one another aspect, the present invention provides an environment friendly solution to the packaging industry.

In yet another aspect, the present method provides a process of synthesis of the water-soluble co-polyester polymer.

Various aspects of the invention will now be described herein in detail. Still other aspects, features, and advantages of the present invention are readily apparent from the entire description thereof, including the embodiments, examples and implementations. Any subject matter described in the specification can be combined with any other subject matter in the specification to form a novel combination. The invention is also capable of other and different examples and aspects, and its several details can be modified in various respects, all without departing from the spirit and scope of the present invention. Accordingly, the descriptions are to be regarded as illustrative in nature, and not as restrictive. Furthermore, the terminology and phraseology used herein is solely used for descriptive purposes and should not be construed as limiting in scope.

### DETAILED DESCRIPTION OF THE INVENTION

### Abbreviations

BOPET: Biaxially oriented polyethylene terephthalate,

PTA: Pure terephthalic acid

IPA: Isophthalic acid

SAMSDE: 5-sulphoisophtalic acid, monosodium salt, dimethyl ester

EG: Ethylene glycol

DEG: Diethylene glycol

HD: Hexane diol, 1,6-Hexanediol

BDO: 1,4-butanediol

PDO: 1,3-propane diol

UOM: Unit of measurement

GSM: Gram per square meter

Min: Minute(s)

Hr/hr: Hour(s)

° C.: Degree Centigrade

### Definitions

It is to be understood that the terminology used herein is for the purpose of describing particular embodiments only, and is not intended to be limiting. As used in this specification and the appended claims, the singular forms “a,” “an” and “the” include plural referents unless the context clearly dictates otherwise. Thus, for example, reference to “monomer” includes one or more such monomers and the like.

Unless defined otherwise, all technical, scientific or other terms used herein have the same meaning as commonly understood by one of ordinary skill in the art to which the invention pertains. Although other methods and materials similar, or equivalent, to those described herein can be used in the practice of the present invention, the preferred materials and methods are described herein.

In describing and claiming the present invention, the following terminology will be used in accordance with the definitions set out below.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The terms “water-soluble co-polyester polymer”, “polymer”, “co-polyester polymer” or “the polymer of the present invention” are used interchangeably and refer to the water soluble co-polyester polymer discloses in the present invention.

The term “monomer” refers to a single molecule or unit, which when go with similar monomer or different monomer for polymerization reaction, synthesizes a polymer.

The term “pre-polymer” refers to a monomer or system of monomers that have been reacted to an intermediate molecular mass state. This material is capable of further polymerization by reactive groups to a fully cured high molecular weight state. As such, mixtures of reactive polymers with un-reacted monomers may also be referred to as pre-polymers.

The term “reaction product” refers to an intended and/or probable resulting product of a chemical reaction under given reaction conditions/parameters e.g. time, temperature and other conditions/parameters.

The term “dicarboxylic acid” refers to an organic compound containing two carboxyl functional groups (—COOH). The term includes the esters/carboxylates of dicarboxylic acids. The dicarboxylic acid used in the present invention can be an aliphatic dicarboxylic acid, an aliphatic dicarboxylate, a cycloaliphatic dicarboxylic acid, a cycloaliphatic dicarboxylate, an aromatic dicarboxylic acid and an aromatic dicarboxylate. The non-exhaustive list of such dicarboxylic acids comprises isophthalic acid, dimethyl isophthalate, terephthalic acid, dimethyl terephthalate, sebacic acid, dimethyl 2,6-naphthalate, naphthalene dicarboxylic acid, dimethyl 1,4-naphthalate, succinic acid, adipic acid, azelaic acid, 2,6-naphthalene dicarboxylic acid, glutaric acid, maleic acid, fumaric acid, oxalic acid, malonic acid, pimelic acid and suberic acid.

The term “diol”, “first diol” or “second diol” refers to a chemical compound containing two hydroxyl group.

The term “aromatic sulfonate” refers to metal salts of aromatic sulfonates. The non-exhaustive list of such aromatic sulfonates comprises sulfonate salts of highly reactive or transition metal e.g. Na, K, Mg, Ca, Ni, or Fe. The non-limiting examples of aromatic sulfonate includes metal salt of sodium 5-sulfophthalic acid, sulfonate isophthalic acid, sulfonate 2,6 naphthalene dicarboxylate or as disclosed in various patent and non-patent documents. Preferably, the aromatic sulfonate is 5-sulphoisophtalic acid, monosodium salt, dimethyl ester.

The term “BOPET” or “PET” are used interchangeably and refers to polyethylene terephthalate. Preferably, the term refers to biaxially oriented polyethylene terephthalate film.

The term “intrinsic viscosity” (I.V.) refers to a measure of a solute's contribution to the viscosity of a solution. I.V. as used herein is measured by dilute solution using an Ubbelohde capillary viscometer.

The term “carboxylic end group content” refers to —COOH end group present at the end of polymer chains and is determined by the method described in the example section of the present disclosure.

The terms “glass transition temperature” and “T_{g}” can be used interchangeably and refer to the temperature at which a chemical compound specifically polymers turn from a ductile and soft material to a hard, brittle or glass like material.

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, 5 to 40 mole % should be interpreted to include not only the explicitly recited limits of 5 to 40 mole %, but also to include sub-ranges, such as 10 mole % to 30 mole %, 7 mole % to 25 mole %, and so forth, as well as individual amounts, including fractional amounts, within the specified ranges, such as 15.5 mole %, 29.1 mole %, and 12.9 mole %.

### I. A WATER-SOLUBLE CO-POLYESTER POLYMER

The present invention discloses a co-polyester polymer. Particularly, a water-soluble co-polyester polymer is disclosed. Specifically, a water-soluble co-polyester polymer used for substrate coating is disclosed. The process of synthesis of the said polymer is also disclosed.

In one embodiment, the present invention discloses a water-soluble co-polyester polymer used for substrate coating is provided.

In one another embodiment, the present invention discloses a water-soluble co-polyester polymer, which can be used for inline or offline coating of substrate to increase their surface energy and surface adhesion.

In one another embodiment, the present invention provides a water-soluble co-polyester polymer, which can be used for inline or offline coating of substrate provide wide range of printability performance.

In one another embodiment, the present invention provides a water-soluble co-polyester polymer, which when inline coated on BOPET films enhance their surface energy, provide wide range of printability performance and metal to film bond strength.

In one another embodiment, the present invention provides a water-soluble co-polyester polymer which when coated metal sheets (e.g. Aluminum) enhance the compatibility and adhesion of ink, provide wide range of printability performance.

In one another embodiment, the present invention provides a water-soluble co-polyester polymer, which imparts excellent adhesion, and printability properties to the substrate when coated with the water-soluble co-polyester polymer.

In one another embodiment, the present invention provides a water-soluble co-polyester polymer, which provides excellent film adhesion to ink when the BOPET is coated with the water-soluble co-polyester polymer. Thus, it provides wide range of printability performance over the BOPET inline coated with the co-polyester polymer of the present invention. Similarly, the inline coating of BOPET with the co-polyester polymer of the present invention also increases adhesion to Aluminum metal in the process of vacuum metallization and thus provide excellent metal to film bond strength.

In one another embodiment, the present invention provides a water-soluble co-polyester polymer, which provides a retort-resistant packaging solution for retort packaging.

In one another embodiment, the present invention provides a water-soluble co-polyester polymer, which can be coated in very thin layer thickness and at very less weight gain.

In one another embodiment, the present invention provides a water-soluble co-polyester polymer for substrate coating, which provide a wide range of printability performance with water-based ink systems, thus avoiding solvent-based ink systems.

In one another embodiment, the present invention provides an environment friendly solution to the packaging industry.

The present invention discloses a water-soluble co-polyester polymer; the polymer comprises a) a pre-polymer (A); and b) a pre-polymer (B); wherein, the pre-polymer (A) comprises a transesterification reaction product of a dicarboxylic acid or ester thereof with a first diol; and the pre-polymer (B) comprises a reaction product of an aromatic sulfonate with a second diol.

The pre-polymer (A) comprises a transesterification reaction product of a dicarboxylic acid or ester thereof with a first diol.

The dicarboxylic acid or ester thereof is selected from an aliphatic dicarboxylic acid, an aliphatic dicarboxylate, a cycloaliphatic dicarboxylic acid, a cycloaliphatic dicarboxylate, an aromatic dicarboxylic acid, an aromatic dicarboxylate or any combination thereof. The non-limiting examples of dicarboxylic acids include isophthalic acid, dimethyl isophthalate, terephthalic acid, dimethyl terephthalate, sebacic acid, dimethyl 2,6-naphthalate, naphthalene dicarboxylic acid, dimethyl 1,4-naphthalate, succinic acid, adipic acid, azelaic acid, 2,6-naphthalene dicarboxylic acid, glutaric acid, maleic acid, fumaric acid, oxalic acid, malonic acid, pimelic acid, suberic acid or any combination thereof. Preferably, the dicarboxylic acid is selected from isophthalic acid, dimethyl isophthalate, terephthalic acid, dimethyl terephthalate or any combination thereof.

In some embodiments, the dicarboxylic acid is isophthalic acid. In some embodiments, the dicarboxylic acid is terephthalic acid. In some embodiments, the dicarboxylic acid is a combination of isophthalic acid and terephthalic acid.

In some preferred embodiments, the dicarboxylic acid is a combination of isophthalic acid and terephthalic acid.

The first diol is selected from an aliphatic diol, a cycloaliphatic diol, an aromatic diol and any combination thereof. The non-limiting examples of first diols include ethylene glycol, diethylene glycol, 1,2-propanediol, 1,3-propaneol, butane diol, 1,3-butanediol, 1,4-butanediol, 1,5-pentanediol, hexane diol, 1,6-hexanediol, cyclohexanedimethanol, 1,4-cyclohexanedimethanol, neopentyl glycol, diethylene glycol, polyethylene glycol, polypropylene glycol, polytetramethylene glycol, bisphenol A., bisphenol S. or any combination thereof.

In some embodiments, the first diol is ethylene glycol. In some embodiments, the first diol is 1,4-butanediol. In some embodiments, the first diol is hexane diol. In some embodiments, the first diol is diethylene glycol. In some embodiments, the first diol is a combination of ethylene glycol and hexane diol. In some embodiments, the first diol is a combination of ethylene glycol and 1,4-butanediol. In some embodiments, the first diol is a combination of ethylene glycol, diethylene glycol and hexane diol. In some embodiments, the first diol is a combination of ethylene glycol, diethylene glycol and 1,4-butanediol.

In some preferred embodiments, the first diol is a combination of ethylene glycol and hexane diol.

In some preferred embodiments, the first diol is a combination of ethylene glycol and 1,4-butanediol.

In some preferred embodiments, the first diol is a combination of ethylene glycol, diethylene glycol and hexane diol.

In some preferred embodiments, the first diol is a combination of ethylene glycol, diethylene glycol and 1,4-butanediol.

In some embodiments, the pre-polymer (A) comprises a transesterification reaction product of a dicarboxylic acid or ester thereof with a first diol; wherein the dicarboxylic acid is a dicarboxylic acid or a combination of dicarboxylic acids; similarly, the first diol is a first diol or a combination of first diols.

In some preferred embodiments, the pre-polymer (A) comprises a transesterification reaction product of a dicarboxylic acid or ester thereof with a first diol; wherein the carboxylic acid is a combination of isophthalic acid and terephthalic acid; and the first diol is a combination of ethylene glycol and hexane diol.

In some preferred embodiments, the pre-polymer (A) comprises a transesterification reaction product of a dicarboxylic acid or ester thereof with a first diol; wherein the carboxylic acid is a combination of isophthalic acid and terephthalic acid; and the first diol is a combination of ethylene glycol and 1,4-butanediol.

In some preferred embodiments, the pre-polymer (A) comprises a transesterification reaction product of a dicarboxylic acid or ester thereof with a first diol; wherein the carboxylic acid is a combination of isophthalic acid and terephthalic acid; and the first diol is a combination of ethylene glycol, diethylene glycol and hexane diol.

In some preferred embodiments, the pre-polymer (A) comprises a transesterification reaction product of a dicarboxylic acid or ester thereof with a first diol; wherein the carboxylic acid is a combination of isophthalic acid and terephthalic acid; and the first diol is a combination of ethylene glycol, diethylene glycol and 1,4-butanediol.

The pre-polymer (B) comprises a reaction product of an aromatic sulfonate with a second diol.

The aromatic sulfonate is selected from sulfonate salts of highly reactive or transition metal e.g. Na, K, Mg, Ca, Ni, or Fe. The non-limiting examples of aromatic sulfonate includes metal salt of sodium 5-sulfophthalic acid, sulfonate isophthalic acid, sulfonate 2,6 naphthalene dicarboxylate or as disclosed in various patent documents or research papers. In some embodiments, the aromatic sulfonate is 5-sulphoisophtalic acid, monosodium salt, dimethyl ester.

In some preferred embodiments, the aromatic sulfonate is 5-sulphoisophtalic acid, monosodium salt, dimethyl ester.

The second diol is selected from the group consisting of an aliphatic diol, a cycloaliphatic diol, an aromatic diol and any combination thereof. The non-limiting examples of second diol include ethylene glycol, diethylene glycol, 1,2-propanediol, 1,3-propaneol, butane diol, 1,3-butanediol, 1,4-butanediol, 1,5-pentanediol, hexane diol, 1,6-hexanediol, cyclohexanedimethanol, 1,4-cyclohexanedimethanol, neopentyl glycol, diethylene glycol, polyethylene glycol, polypropylene glycol, polytetramethylene glycol, bisphenol A., bisphenol S. or any combination thereof.

In some embodiments, the second diol is ethylene glycol. In some embodiments, the second diol is diethylene glycol. In some embodiments, the second diol is 1,4-butane diol.

In some preferred embodiments, the second diol is ethylene glycol.

In some embodiments, the pre-polymer (B) comprises a reaction product of an aromatic sulfonate with a second diol; wherein the aromatic sulfonate an aromatic sulfonate or a combination of more than one aromatic sulfonates; similarly, the second diol is a second diol or a combination of more than one second diols.

In some preferred embodiments, the pre-polymer (B) comprises a reaction product of an aromatic sulfonate with a second diol; wherein the aromatic sulfonate is 5-sulphoisophtalic acid, monosodium salt, dimethyl ester; and the second diol is ethylene glycol.

In some preferred embodiments, the pre-polymer (B) comprises a reaction product of an aromatic sulfonate with a second diol; wherein the aromatic sulfonate is 5-sulphoisophtalic acid, monosodium salt, dimethyl ester; and the second diol is a combination of ethylene glycol and 1,4-butanediol.

It is understood that each description of dicarboxylic acid may be combined with each description of the first diol the same as if each and every combination were specifically and individually listed. Similarly, it is understood that each description of aromatic sulfonate may be combined with each description of the second diol the same as if each and every combination were specifically and individually listed. It is similarly understood that each description of pre-polymer (A) (each description of the dicarboxylic acid with each description of the first diol) may be combined with each description of pre-polymer (B) (each description of the aromatic sulfonate with each description of the second diol).

The water-soluble co-polyester polymer disclosed herein are used to coat one or more substrates. The substrates include but not limited to BOPET film, BOPET primer for metallization and Aluminum sheets (preferably Aluminum sheets used to manufacture Aluminum can).

The polymer of the present invention can be coated on the BOPET film during inline manufacturing process. The coating can also be done offline while coating on Aluminum sheets.

The polymer of the present invention imparts excellent surface characteristics to the coated surface e.g. surface energy, adhesion, printability, metal to film bond strength etc. The polymer of the present invention also coats the surface very efficiently in minimum weight gain.

The surface coated with the polymer disclosed in the present invention can be printed using a wide range of ink systems e.g. water-based inks and solvent-based ink system. The polymer of the present invention is also used with the UV curable inks to coat the surface of the substrates.

The polymer of the present invention exhibits an intrinsic viscosity (I.V.) from about 0.3 to 0.7 dL/g. Preferably, the polymer of the present invention exhibits an intrinsic viscosity (I.V.) from about 0.35 to 0.6 dL/g. More preferably, the polymer of the present invention exhibits an intrinsic viscosity (I.V.) from about 0.35 to 0.55 dL/g.

The polymer of the present invention exhibits a carboxylic content from 25 to 150 meq/Kg. Preferably, the polymer of the present invention exhibits a carboxylic content from 25 to 140 meq/Kg. More preferably, the polymer of the present invention exhibits a carboxylic content from 25 to 120 meq/Kg.

The polymer of the present invention exhibits a glass transition temperature from 45° C. to 60° C. Preferably, the polymer of the present invention exhibits a glass transition temperature from 50° C. to 60° C. More preferably, the polymer of the present invention exhibits a glass transition temperature from 50° C. to 55° C.

The polymer of the present invention when coated over a 12 micron BOPET film in inline manufacturing process, the coating is done at a coating thickness from 0.01 to 0.09 GSM. Preferably, the coating is done at a coating thickness from 0.02 to 0.08 GSM. More preferably, the coating is done at a coating thickness from 0.02 to 0.07 GSM.

The polymer of the present invention when coated over a 12 micron BOPET film at a coating thickness from 0.01 to 0.09 GSM and then the coated BOPET film is printed, the coated and printed BOPET film exhibits resistance to ink adhesion test in Tape Test after sustaining boiling water test for 0.5 to 2 hr. Preferably, the coated and printed BOPET film exhibits resistance to ink adhesion test in Tape Test after sustaining boiling water test for 1 hr. More preferably, the coated and printed BOPET film exhibits resistance to ink adhesion test in Tape Test after sustaining boiling water test for 0.5 hr.

The polymer of the present invention when coated over a 12 micron BOPET film at a coating thickness from 0.01 to 0.09 GSM, then the coated BOPET film is vacuum metallized with an optical density from 0.5 to 3.2. Preferably, the coated BOPET film is vacuum metallized with an optical density from 1.5 to 3.2. More preferably, the coated BOPET film is vacuum metallized with an optical density from 1.8 to 3.2.

The polymer of the present invention when coated over a 12 micron BOPET film at a coating thickness from 0.01 to 0.09 GSM and then the coated BOPET film is metallized with Aluminum; the coated and metallized BOPET film exhibits a metal to film bond strength from 800 g/inch to 1700 Winch. Preferably, the coated and metallized BOPET film exhibits a metal to film bond strength from 800 Winch to 1500 Winch. More preferably, the coated and metallized BOPET film exhibits a metal to film bond strength from 850 Winch to 1500 Winch.

The polymer of the present invention when coated over a 12 micron BOPET film at a coating thickness from 0.01 to 0.09 GSM and then the coated BOPET film is printed with various retort ink(s), the printed film is then subjected to lamination with Aluminum foil, retort cast polypropylene film, nylon film and with retort adhesive sequentially to make layered/composite film, the resulted layered/composite film exhibits no delamination after high retort sterilization at 120° C. to 140° C. for 5 to 30 min; The layered/composite film exhibits no delamination after retort sterilization at 100° C. to 120° C. for 5 to 15 min. The layered/composite film exhibits no delamination after boil sterilization at 90° C. to 100° C. for 30 to 120 min.

### II. PROCESS OF SYNTHESIS OF WATER-SOLUBLE CO-POLYESTER POLYMERS

The present invention also discloses a process of synthesis of a water-soluble co-polyester polymer.

The present invention discloses a process of synthesis of a water-soluble co-polyester polymer; the process comprising polymerizing a) a pre-polymer (A); and b) a pre-polymer (B); wherein, the pre-polymer (A) comprises a transesterification reaction product of a dicarboxylic acid or ester thereof with a first diol; and the pre-polymer (B) comprises a reaction product of an aromatic sulfonate with a second diol.

In another way, the present invention discloses a process of synthesis of a water-soluble co-polyester polymer; the process comprising the steps of: a) synthesizing a pre-polymer (A); b) synthesizing a pre-polymer (B); and c) polymerizing the pre-polymer (A) and the pre-polymer (B); wherein, the pre-polymer (A) comprises a transesterification reaction product of a dicarboxylic acid or ester thereof with a first diol; and the pre-polymer (B) comprises a reaction product of an aromatic sulfonate with a second diol.

### A. Synthesis of Pre-Polymer (A)

The pre-polymer (A) is synthesized by carrying out transesterification reaction between a dicarboxylic acid and a first diol.

The dicarboxylic acid and the first diol may be one dicarboxylic acid and one diol; or can be a mixture of dicarboxylic acids and diols.

The dicarboxylic acid or ester thereof is selected from an aliphatic dicarboxylic acid, an aliphatic dicarboxylate, a cycloaliphatic dicarboxylic acid, a cycloaliphatic dicarboxylate, an aromatic dicarboxylic acid, an aromatic dicarboxylate or any combination thereof. The non-limiting examples of dicarboxylic acids include isophthalic acid, dimethyl isophthalate, terephthalic acid, dimethyl terephthalate, sebacic acid, dimethyl 2,6-naphthalate, naphthalene dicarboxylic acid, dimethyl 1,4-naphthalate, succinic acid, adipic acid, azelaic acid, 2,6-naphthalene dicarboxylic acid, glutaric acid, maleic acid, fumaric acid, oxalic acid, malonic acid, pimelic acid, suberic acid or any combination thereof. Preferably, the dicarboxylic acid is selected from isophthalic acid, dimethyl isophthalate, terephthalic acid, dimethyl terephthalate and any combination thereof.

In some embodiments, one dicarboxylic acids is used. In some embodiments, the dicarboxylic acids are used in mixture. In one embodiment, the dicarboxylic acids are selected from aromatic dicarboxylic acid. In one embodiment, the dicarboxylic acids are selected from dimethyl terephthalate, pure terephthalate, isophthalic acid, ortho-phthalic acid, dimethyl 2,6-naphthalate and naphthalene di-carboxylic acid. The aromatic di-carboxylic acid is used from 1 to 100 mole %; preferably from 10 to 80 mole %; more preferably from 10 to 60 mole %. In one embodiment, the dicarboxylic acids are selected from aliphatic dicarboxylic acid. In one embodiment, the dicarboxylic acids are selected from suberic acid, adipic acid and oxalic acid. The aliphatic dicarboxylic acids are used from 1 to 100 mole %; preferably from 5 to 80 mole %.

The first diol is selected from ethylene glycol, 1,2-propanediol, 1,3-propanediol, 1,3-butanediol, 1,4-butanediol, 1,5-pentanediol, 1,6-hexanediol, neopentyl glycol, diethylene glycol, polyethylene glycol, polypropylene glycol, polytetramethylene glycol and 1,4-cyclohexanedimethanol. The first diols are used from 1 to 100 mole %; preferably from 5 to 80 mole %.

The transesterification reaction is carried out in presence of one or more catalyst. The catalyst system is selected from Antimony trioxide and Titanium-based catalyst; preferably, the catalyst is Antimony trioxide. The catalyst is used in monomer slurry at a concentration ranging from 1 to 1000 ppm; preferably, from 10 to 600 ppm.

The transesterification reaction is carried out in presence of one or more heat stabilizer. The heat stabilizer is selected from ortho phosphoric acid or poly phosphoric acid; preferably poly phosphoric acid from 1 to 1000 ppm; more preferably from 10 to 600 ppm.

The temperature of the transesterification reaction is maintained from 200° C. to 300° C.; preferably from 240° C. to 280° C.

For synthesis of pre-polymer (A) the transesterification reaction is carried out from 2 to 5 hr; preferably from 2 to 4 hr. The catalyst and heat stabilizer added in slurry mixture. After transesterification was complete, which was confirmed by removal of quantity of water.

### B. Synthesis of Pre-Polymer (B)

The pre-polymer (B) is synthesized by carrying out reaction between an aromatic sulfonate dicarboxylic acid and a second diol.

The aromatic sulfonate is selected from sulfonate salts of highly reactive or transition metal e.g. Na, K, Mg, Ca, Ni, or Fe. The non-limiting examples of aromatic sulfonate includes metal salt of sodium 5-sulfophthalic acid, sulfonate isophthalic acid, sulfonate 2,6 naphthalene dicarboxylate or as disclosed in various patent and non-patent documents. In some embodiments, the aromatic sulfonate is 5-sulphoisophtalic acid, monosodium salt, dimethyl ester.

In one preferred embodiments, the aromatic sulfonate is 5-sulphoisophtalic acid, monosodium salt, dimethyl ester.

The second diol is selected from the group consisting of an aliphatic diol, a cycloaliphatic diol, an aromatic diol and any combination thereof. The non-limiting examples of second diol include ethylene glycol, diethylene glycol, 1,2-propanediol, 1,3-propaneol, butane diol, 1,3-butanediol, 1,4-butanediol, 1,5-pentanediol, hexane diol, 1,6-hexanediol, cyclohexanedimethanol, 1,4-cyclohexanedimethanol, neopentyl glycol, diethylene glycol, polyethylene glycol, polypropylene glycol, polytetramethylene glycol, bisphenol A., bisphenol S. or any combination thereof.

In some embodiments, the second diol is ethylene glycol. In some embodiments, the second diol is diethylene glycol. In some embodiments, the second diol is 1,4-butane diol.

In one preferred embodiment, the second diol is ethylene glycol.

The sulfonated pre-polymer (B) is synthesized as per the process disclosed in the PCT Application No. WO2015124959A1.

### C. Polymerization of Pre-Polymer (A) and Pre-Polymer (B)

The process of synthesizing water soluble co-polyester polymer of the present invention; the process comprises polymerizing the pre-polymer (A) and pre-polymer (B).

The pre-polymer (A) and pre-polymer (B) were taken in a Wt. % from 1 to 90% by w/w and 5 to 60% by weight respectively.

The polymerization reaction is carried out in negative pressure, preferably in vacuum.

The polymerization is carried out in the presence of one or more catalyst.

The polymerization reaction was carried out for about 2 to 4.5 hr; preferably 2 to 4 Hr.

The temperature of the polymerization reaction was maintained from 220° C. to 350° C.; preferably, from 230° C. to 290° C.

The process of synthesis disclosed in the present invention wherein the polymer synthesized by the process is used to coat one or more substrates. The substrates include but not limited to BOPET film, BOPET primer for Aluminum metallization and Aluminum sheets.

The process of synthesis disclosed in the present invention wherein the polymer synthesized by the process can be coated on the BOPET film during inline manufacturing process. The coating can also be done offline while coating on Aluminum sheets.

The process of synthesis disclosed in the present invention wherein the polymer synthesized by the process imparts excellent surface characteristics to the coated surface e.g. surface energy, adhesion, printability, metal to film bond strength etc. The polymer of the present invention also coats the surface very efficiently in minimum weight gain.

The process of synthesis disclosed in the present invention wherein the polymer synthesized by the process can be printed using a wide range of ink systems e.g. water-based inks and solvent-based ink system. The polymer of the present invention is also used with the UV curable inks to coat the surface of the substrates.

The polymer synthesized by the process disclosed herein exhibits an intrinsic viscosity (I.V.) from about 0.3 to 0.7 dL/g. Preferably, the polymer exhibits an intrinsic viscosity (I.V.) from about 0.35 to 0.6 dL/g. More preferably, the polymer exhibits an intrinsic viscosity (I.V.) from about 0.35 to 0.55 dL/g.

The polymer synthesized by the process exhibits a carboxylic content from 15 to 150 meq/Kg. Preferably, the polymer exhibits a carboxylic content from 25 to 140 meq/Kg. More preferably, the polymer exhibits a carboxylic content from 25 to 120 meq/Kg.

The polymer synthesized by the process disclosed herein exhibits a glass transition temperature from 45° C. to 60° C. Preferably, the polymer exhibits a glass transition temperature from 50° C. to 60° C. More preferably, the polymer exhibits a glass transition temperature from 50° C. to 55° C.

The polymer synthesized by the process disclosed herein when coated over a 12 micron BOPET film in inline manufacturing process, the coating is done at a coating thickness from 0.01 to 0.09 GSM. Preferably, the coating is done at a coating thickness from 0.02 to 0.08 GSM. More preferably, the coating is done at a coating thickness from 0.02 to 0.07 GSM.

The polymer synthesized by the process disclosed herein when coated over a 12 micron BOPET film at a coating thickness from 0.01 to 0.09 GSM and then the coated BOPET film is printed, the coated and printed BOPET film exhibits resistance to ink adhesion test in Tape Test after sustaining boiling water test 0.5 to 2 hr. Preferably, the coated and printed BOPET film exhibits resistance to ink adhesion test in Tape Test after sustaining boiling water test for 1 hr. More preferably, the coated and printed BOPET film exhibits resistance to ink adhesion test in Tape Test after sustaining boiling water test for 0.5 hr.

The polymer synthesized by the process disclosed herein when coated over a 12 micron BOPET film at a coating thickness from 0.01 to 0.09 GSM, then the coated BOPET film is metallized with Aluminum with an optical density from 0.5 to 3.2. Preferably, the coated BOPET film is metallized with Aluminum with an optical density from 1.5 to 3.2. More preferably, the coated BOPET film is metallized with Aluminum with an optical density from 1.8 to 3.2.

The polymer synthesized by the process disclosed herein when coated over a 12 micron BOPET film 0.01 to 0.09 GSM and then the coated BOPET film is vacuum metallized with Aluminum exhibits a metal to film bond strength from 800 Winch to 1700 Winch. Preferably, the metallized film exhibits a metal to film bond strength from 800 Winch to 1500 g/inch. More preferably, the metallized film exhibits a metal to film bond strength from 850 Winch to 1500 Winch.

The polymer synthesized by the process disclosed herein when coated over a 12 micron BOPET film 0.01 to 0.09 GSM and then the coated BOPET film is printed with various retort ink(s), the printed film is then subjected to lamination with Aluminum foil, retort cast polypropylene film, nylon film and with retort adhesive sequentially to make layered/composite film, the resulted layered/composite film exhibits no delamination after high retort sterilization at 120° C. to 140° C. for 5 to 30 min. The layered/composite film exhibits no delamination after retort sterilization at 100° C. to 120° C. for 5 to 15 min. The layered/composite film exhibits no delamination after boil sterilization at 90° C. to 100° C. for 30 to 120 min.

### General Procedures

Synthesis of Water Soluble Co-Polyester Polymer:

### Procedure

Step: 1: Synthesis of Pre-polymer (A): Dicarboxylic acids and diols were taken together in a reactor vessel. The catalyst Antimony Trioxide and heat stabilizer poly phosphoric acid were added in a concentration ranging from 10-600 ppm and 10-600 ppm respectively. The reactants were allowed to react for about 2 to 3.5 Hr at a temperature ranging from 240° C. to 280° C. The reaction completion was validated by the removal of water.

Step: 2: Synthesis of sulfonated Pre-polymer (B): Sulfonated pre-polymer was synthesized as disclosed in various publications and patent documents. The sulfonated pre-polymer was synthesized by the method disclosed in PCT Published Application No. WO2015124959A1 (Kulkarni et al.).

Step: 3: Synthesis of Polymer:

The pre-polymer (A) and pre-polymer (B) were added in a reactor vessel. The vacuum was applied to the reaction. Then, the pre-polymers were allowed to react for about 2.5 to 4 hr at a temperature ranging from 230° C. to 290° C.

Typical formula of the polymer of the present invention are given in table-1. Different polymers were synthesized through general procedures given herein.

For formula 1 to 3, isophthalic acid and pure terephthalic acid were taken as carboxylic acids; ethylene glycol, diethylene glycol and hexane diol were taken as the first diol. 5-sulphoisophtalic acid, monosodium salt, dimethyl ester was taken as aromatic sulfonate and ethylene glycol was taken as the second diol. For formula 4 to 7, isophthalic acid and pure terephthalic acid were taken as carboxylic acids; ethylene glycol and hexane diol were taken as the first diol. 5-sulphoisophtalic acid, monosodium salt, dimethyl ester was taken as aromatic sulfonate and ethylene glycol was taken as the second diol. For formula 8, isophthalic acid and pure terephthalic acid were taken as carboxylic acids; ethylene glycol, hexane diol and 1,4-butane diol were taken as the first diol. 5-sulphoisophtalic acid, monosodium salt, dimethyl ester was taken as aromatic sulfonate and ethylene glycol was taken as the second diol. For formula 9, isophthalic acid and pure terephthalic acid were taken as carboxylic acids; ethylene glycol and 1,4-butane diol were taken as the first diol. 5-sulphoisophtalic acid, monosodium salt, dimethyl ester was taken as aromatic sulfonate and ethylene glycol was taken as the second diol.

Different batches of the polymer of the present inventions were synthesized and evaluated. The evaluation characteristics of the polymers synthesized, coated PET film, vacuum metallized BOPET film and composite film are given in tables 2-5.

TABLE-1
Formulation of typical examples of
the polymer of the present invention

| | Wt. % | | | | | | |
|---|---|---|---|---|---|---|---|
| Formula | PTA | IPA | SAMSDE | EG | DEG | HD | BDO |
| 1. | 54.7 | 8.6 | 7.2 | 20.3 | 1.4 | 7.8 | — |
| 2. | 51.82 | 8.17 | 6.83 | 24.15 | 1.31 | 7.73 | — |
| 3. | 43.48 | 6.88 | 7.81 | 34.56 | 1.09 | 6.17 | — |
| 4. | 41.55 | 7.53 | 7.46 | 33.97 | — | 9.49 | — |
| 5. | 44.24 | 7.00 | 6.06 | 36.18 | — | 6.52 | — |
| 6. | 48.83 | 7.73 | 6.69 | 29.56 | — | 7.19 | — |
| 7. | 53.38 | 6.47 | 6.06 | 27.50 | — | 6.59 | |
| 8. | 54.7 | 8.6 | 7.20 | 20.3 | 1.4 | — | 7.8 |
| 9. | 44.24 | 7.00 | 6.06 | 36.18 | — | — | 6.52 |

### D. Coating of the Present Polymer on BOPET Film

### (i) Preparation of Coating Solution:

A solution of polymer of the present invention is prepared by dissolving a weighed quantity (10% w/v) of the polymer in a solvent mixture water: Isopropyl Alcohol (90:10) at 90° C. with agitation with a water cooled condenser tank for about 2-4 hr. The polymer of the present invention was dissolved completely without leaving any undissolved residue or leaving negligible residue. The solution was cooled down to room temperature and filtered with 10 to 40 micron filter mesh. A surfactant was added to the solution ranging from 0.001 to 0.008 weight %. Colloidal silica was added to the solution from 0.1 to 0.8 weight %.

### (ii) Coating of BOPET Films

BOPET films were coated with the solution of the polymer of the present invention by inline polyester film manufacturing after machine direction orientation and before transverse direction orientation. The coated with films were further subjected to transverse orientation with crystallization and drying process at temperature range of 80° C. to 240° C. with 1.5 to 5 times stretching. Polymers of the present invention were coated with horizontal gravure kiss coating system during manufacturing of BOPET films. The coating thickness maintained from 0.01 to 0.09 GSM.

### E. Preparation of Layered/Composite Film:

A layered/composite film was made by coating the BOPET film with the polymer of the present invention (at a coating thickness from 0.01 to 0.09) in inline manufacturing process. The coated film is then printed with various retort ink(s), the printed film is then laminated with Aluminum foil, retort cast polypropylene film, nylon film and with retort adhesive sequentially to make layered/composite film. The layered/composite film was made by the methods and procedures known in the relevant art. This layered/composite films were subjected to retort test.

### III. EVALUATIONS

The water-soluble co-polyester polymers disclosed herein were synthesized and evaluated for various quality characteristics. These characteristics includes intrinsic viscosity (I.V.), carboxylic end group content, glass transition temperature (T_{g}), tensile strength, thermal shrinkage, haze, surface energy, co-efficient of friction, coating thickness, boiling test for ink removal, metallization efficiency, optical density, metal to film bond strength, water vapour transmission rate (WVTR), oxygen transmission rate (OTR) and retort sterilization. Average test results are given in the tables 2 to 5.

### A. Evaluation of Water-Soluble Co-Polyester Polymer

### (i) Intrinsic Viscosity (I.V.):

Intrinsic viscosity was measured by dissolving 0.25±0.002 co-polyester polymer in a solvent system of Phenol and 1,1,2,2 tetrachloro ethane (60:40 w/w) using Ubbelohde capillary viscometer. The results for water soluble polymers synthesized as per the present invention are given given in table-2.

### (ii) Carboxylic End Group (—COOH) Content:

Carboxylic end group content measurement was done using approximate 1.0±0.02 g of co-polyester dissolved in solvent system Phenol: Chloroform (50:50 w/w). The resultant solution was titrated with 0.02 N Benzyl-KOH. Approx. 4 drops of bromophenol blue was used as indicator. The results for water soluble polymers synthesized as per the present invention are given given in table-2.

(iii) Glass Transition Temperature (T_{g}):

Glass transition temperature (T_{g}) was measured by differential scanning calorimetry (DSC). The results for water soluble polymers synthesized as per the present invention are given given in table-2.

### (iv) Colour Test:

Colour was tested by using HunterLab® apparatus. The results for water soluble polymers synthesized as per the present invention are given given in table-2.

TABLE 2
Evaluation results for the polymer disclosed in the present invention

| Quality | | | |
|---|---|---|---|
| characteristics | | Unit of Measurement | Readings |
| Intrinsic Viscosity | | dL/g | 0.3 to 0.7 |
| (I.V.) | | | |
| (—COOH) | | meq/Kg | 25 to 150 |
| End group | | | |
| Glass Transition | | ° C. | 50 to 60 |
| Temperature (T_{g}) | | | |
| Color | L* | — | 50 to 80 |
| Value | a* | — | −0.1 to 5.0 |
| | b* | — | −2 to 10 |

B. Evaluation of 12 Micron BOPET Film Inline Coated with Polymers of the Present Invention

### (i) Tensile Strength:

The tensile properties were measured by using universal tensile testing machine (UTM) as per ASTM D882. The results given given in table-3.

### (ii) Thermal Shrinkage:

Thermal shrinkage of film was measured according to ASTM D2838, where in samples were cut in required sizes (254 mm×254 mm), initial dimensions were measured and marked as Machine Direction (MD) and Transverse Direction (TD) on the sample, which were placed in an oven at 150° C. for 30 min. The sample were taken out after 30 min. and allowed to cool at room temperature. The final dimensions of sample were measured again to check the shrinkage. The results are given given in table-3.

(iii) Haze and Transmittance:

Haze % and transmittance % of the film is measured by using a Haze meter or by a spectrophotometer, according to ASTM D1003. The results are given in table-3.

### (iv) Surface Energy:

Surface energy was tested as per the ASTM D 2578 standard. The results are given given in table-3.

### (v) Co-Efficient of Friction:

The co-efficient of friction was tested as per the ASTM D 1894 standard. The results are given given in table-3.

### (vi) Coating Thickness:

Coating thickness was measured by gm/m². In order to determine coating thickness, samples were cut in the size of 100×100 mm templates and their weight were measured using weighing balance having accuracy of 0.001 gm. Thereafter, the coating of the film was removed by suitable solvent and the samples are weighed again. The difference of weight of the sample was used to measure coating thickness using following formula. Average GSM=(weight difference of sample in gm)/(length in meter×width in meter). The results are given given in table-3.

(vii) Ink-Adhesion Test (Tape Test):

The coated films were printed with one to six colors in a conventional gravure printing machine using solvent-based ink. The printed films were then kept on a glass container at 90 to 100° C. in boiling water for about 2 hr. Then the films were dried and checked for tape test using 3M tape number 610 for ink adhesion test. A conventional corona treated BOPET film was also carried out for the same test. The results are given given in table-3.

TABLE 3
Evaluation results for the 12 micron BOPET coated with the
polymer disclosed in the present invention

| | | Polymer of | 12 microns |
|---|---|---|---|
| | Unit of | the present | corona treated |
| Test | Measurement | invention | BOPET |
| Tensile strength | Kg/cm² | 1600 to 2500 | 1600 to 2500 |
| MD and TD - | | | |
| ASTM D 882 | | | |
| Thermal - Shrinkage | % | 1-3 in MD, | 1-3 in MD, |
| MD and TD - | | 0-1 in TD | 0-1 in TD |
| ASTM D 1204 | | | |
| Haze - ASTM D | % | 1 to 5 | 1 to 5 |
| 1003 | | | |
| Surface Energy - | Dyne/cm | 58 to 70 | 50 to 56 |
| ASTM D 2578 | | | |
| Co-efficient of | — | 0.45-0.7 Static, | 0.45-0.7 Static, |
| Friction - Static | | 0.4-0.65 | 0.4-0.65 |
| and Dynamic - | | Dynamic | Dynamic |
| ASTM D 1894 | | | |
| Coating GSM | g/m² | 0.01 to 0.09 | — |
| Ink adhesion test | — | No ink | Complete Ink |
| for 2 hr in boiling | | removed | removed |
| water | | | |

C. Evaluation of 12 Micron BOPET Film Inline Coated with Polymers (0.010 to 0.090 GSM) then Vacuum Metallized with Aluminum Metal

### (i) Optical Density:

Optical density was measured using Tobias instrument. The results are given given in table-4.

(iii) Metal to Film Bond Strength:

Metal to film bond strength was measured by AIMCAL standard. The results are given given in table-4.

### (iv) Water Vapor Transmission Rate (WVTR):

Water Vapor Transmission Rate (WVTR) of metallized film was evaluated as per ASTM F372 by using MOCON PERMATRAN 3/33 at the test condition of 38° C. and 90% RH (Relative Humidity). The results are given given in table-4.

### (v) Oxygen Transmission Rate (OTR):

Oxygen transmission rate (OTR) of metallized film was evaluated according to ASTM D 3985 using Mocon OX-TRAN® 2/21 instrument at test condition of 23° C. and 0% Relative Humidity (RH). The results are given given in table-4.

TABLE 4
Evaluation results for the 12 micron BOPET coated with the polymer
then metallized with Aluminum

| | Unit of | Polymer of the present |
|---|---|---|
| Quality Parameter | Measurement | invention |
| GSM | g/m² | 0.01 to 0.09 |
| Optical Density | — | 0.5 to 3.2 |
| Metal to film bond | gm/inch | 800 to 1500 |
| strength | | |
| (AIMCALtest | | |
| procedure) | | |
| WVTR (38° C. & | gm/m²/day | 0.2 to 2.5 |
| 90% RH) | | |
| OTR (23° C. & 0% RH) | cc/m²/day | 0.2 to 3.5 |

### C. Evaluation of Composite Film:

### (i) Retort Sterilization:

### Preparation of Layered/Composite Film:

Layered/composite films were manufactured using the polymer of the present invention were subjected to retort test on different temperatures for different durations. The results of retort sterilization are given in the table-5.

TABLE 5
Evaluation results for Retort sterilization

| Temp. | Time | | Polymer of the present |
|---|---|---|---|
| (° C.) | (min) | Retort Type | invention |
| 120 to 140 | 5 to 30 | High Retort | No delamination after retort |
| | | Sterilization | |
| 100 to 120 | 5 to 15 | Retort | No delamination after retort |
| | | Sterilization | |
| 90 to 100 | 30 to 120 | Boil Sterilization | No delamination after retort |

### IV. OBSERVATION AND CONCLUSION

The results showed that the polymer of the present invention coated the substrates BOPET films in very less weight gain (very less GSM) i.e. 0.01 to 0.09 GSM. Further, the metal to film bond strength offered by the polymer of the present invention was very strong. The polymer of the present invention also showed excellent printability with boiling water resistance and retort resistance. The polymer of the present invention can be used for inline coating BOPET films and for BOPET film primer for metallization. The thin coating and boiling water test also make the polymer eligible for coating Aluminum sheets used to manufacture Aluminum cans to offer better printability. The polymer of the present invention is also good for retort packaging. The most important thing is that the polymer of the present invention can be used with water-based ink systems as well as solvent-based ink systems.

The present description is the best presently-contemplated system and method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest cope consistent with the principles and features described herein.

What is claimed is:

1. A water soluble co-polyester polymer; the polymer comprises:
(a) a pre-polymer (A); and
(b) a pre-polymer (B);
wherein:
the pre-polymer (A) comprises a transesterification reaction product of a dicarboxylic acid or ester thereof with a first diol; and
the pre-polymer (B) comprises a reaction product of an aromatic sulfonate with a second diol.

2. (canceled)

3. (canceled)

4. The polymer of claim 1, wherein the dicarboxylic acid is a combination of isophthalic acid and terephthalic acid.

5. (canceled)

6. (canceled)

7. The polymer of claim 1, wherein the first diol is a combination of ethylene glycol and hexane diol.

8. The polymer of claim 1, wherein the first diol is a combination of ethylene glycol and 1,4-butanediol.

9. The polymer of claim 1, wherein the first diol is a combination of ethylene glycol, diethylene glycol and hexane diol.

10. The polymer of claim 1, wherein the first diol is a combination of ethylene glycol, diethylene glycol and 1,4-butanediol.

11. The polymer of claim 1, wherein the aromatic sulfonate is 5-sulphoisophtalic acid, monosodium salt, dimethyl ester.

12. (canceled)

13. (canceled)

14. The polymer of claim 1, wherein the second diol is ethylene glycol.

15. The polymer of claim 1, wherein the polymer is used for inline coating of BOPET film manufacturing, coating of BOPET film used as primer for vacuum metallization, surface coating of Aluminum sheets.

16. The polymer of claim 1, wherein the polymer exhibit at least one of:
a) an intrinsic viscosity (I.V.) from 0.3 to 0.7 dL/g;
b) a carboxylic end group content from 25 to 150 meq/Kg; and
c) a glass transition temperature from 50° C. to 60° C.

17. The polymer of claim 1, wherein a 12 micron BOPET film inline coated with the polymer exhibit at least one of:
a) a coating at 0.01 to 0.09 GSM; and
b) a surface energy of 58-70 Dyne/cm;
c) a resistance to ink adhesion in Tape Test after sustaining boiling water test for 0.5 to 2 hr.

18. The polymer of claim 1, wherein a 12 micron BOPET film inline coated with the polymer and then vacuum metallized with Aluminum at a range of optical density from 1.5 to 3 exhibits a metal to film bond strength from 800 g/inch to 1500 Winch; preferably, from 1000 Winch to 1500 Winch.

19. The polymer of claim 1, wherein a 12 micron BOPET film inline coated with the polymer and then the coated BOPET film is printed with one or more retort inks, the printed film is then subjected to lamination with Aluminum foil, retort cast polypropylene film, nylon film and with retort adhesive sequentially to make layered/composite film, the layered/composite film exhibits at least one of:
a) no delamination of printed BOPET after high retort sterilization at 120° C. to 140° C. for 5 to 30 min;
b) no delamination of printed BOPET after retort sterilization at 100° C. to 120° C. for 5 to 15 min; and
c) no delamination of Printed BOPET after boil sterilization at 90° C. to 100° C. for 30 to 120 min.
